(19) United States
(12) Patent Application Publication
(10) Pub. No.: US 2014/0255151 A1
(43) Pub. Date: Sep. 11, 2014

(54) Fluid Turbine With Slip Ring

(71) Applicant: Ogin, Inc., Waltham, MA (US)

(72) Inventor: Rasmus Peter Jensen, Gjern (DK)

(73) Assignee: Ogin, Inc., Waltham, MA (US)

(21) Appl. No.: 14/198,362

(22) Filed: Mar. 5, 2014

Related U.S. Application Data
(60) Provisional application No. 61/772,677, filed on Mar. 5, 2013.

(51) Int. Cl. F03D 11/00; F03D 7/02; F03D 7/04; F03D 1/04

(52) U.S. Cl. CPC F03D 11/0066; F03D 1/04; F03D 7/0204; F03D 7/04
USPC 415/4.3; 415/121.3; 415/118; 29/888

(57) ABSTRACT

Example embodiments are directed to fluid turbines that include a turbine shroud and a rotor assembly disposed within the turbine shroud. The rotor assembly includes a nacelle pivotally engageable with a tower structure and a slip ring disposed within the nacelle. The slip ring electrically connects one or more cables in the nacelle to one or more cables in the tower structure. The slip ring is engaged with the nacelle by a mounting apparatus which allows movement of the slip ring along at least one of an x-axis, a y-axis and a z-axis. Example embodiments are further directed to methods of maintaining untwisted electric cables in a fluid turbine.

### CROSS-REFERENCE TO RELATED APPLICATIONS

The present application claims the benefit of priority of U.S. provisional patent application entitled “Fluid Turbine Slip Ring Configuration” which was filed on Mar. 5, 2013, and assigned Ser. No. 61/772,677. The entire content of the foregoing provisional application is incorporated herein by reference.

### TECHNICAL FIELD

The present disclosure relates to turbines for power generation and, in particular, to shrouded fluid turbines including a slip ring for transmission of electrical power or communication signals or both from a rotating component of the fluid turbine to a stationary component of the fluid turbine. The present disclosure further relates to shrouded fluid turbines including an encoder engaged with the slip ring for determining an angle of rotation of the rotating component of the fluid turbine relative to the stationary component of the fluid turbine.

### BACKGROUND

Conventional horizontal axis fluid turbines used for power generation are known to include blades, e.g., one to five open blades, arranged like a propeller, and further include a rotor assembly. The blades are typically mounted to a horizontal shaft attached to a gear box which drives at least one power generator. The rotor assembly transforms fluid stream energy into a rotational torque that drives the power generator that is rotationally coupled to the rotor assembly either directly or through a transmission to convert mechanical energy into electrical energy.

Fluid turbines typically include a means of rotating into the direction of the fluid stream and means to untwist power transfer cables which connect a rotating component of the fluid turbine to the stationary component of the fluid turbine. As an example, some fluid turbines include a pivot structure for allowing rotation of the rotating component relative to the stationary component. Power transfer cables are typically designed to withstand a given amount of twist without breaking. Yaw mechanisms are generally used to rotate the fluid turbine in both clockwise and counter-clockwise directions to prevent or limit excessive twisting of the power transfer cables. Power transfer cables that are designed to withstand twist are generally also designed to withstand lateral flexing. Lateral flexing can be represented by the variation in the alignment of a yaw axis of a nacelle of the fluid turbine with a vertical axis of a tower structure of the fluid turbine.

Fluid turbines, e.g., wind turbines, can be located in areas having relatively predictable wind patterns, e.g. varying between approximately 15 m/s and approximately 25 m/s. However, during storm conditions, wind speeds can reach extreme levels capable of damaging the structures associated with the fluid turbine. Fluid turbines are typically constructed and reinforced to withstand the effects of high fluid speeds likely to be experienced in extreme wind conditions. However, excessive wind conditions and/or high speed wind gusts can cause significant fatigue loads on the structural components of the fluid turbine. Shrouded or ducted fluid turbines present additional structural surface area resulting in additional drag and, therefore, additional fatigue loads and stress on structural components of the fluid turbine. In general, shrouded or ducted fluid turbines can exhibit greater loads on the structural components of the fluid turbine than non-ducted fluid turbines. In addition, the loads on the structural components of the fluid turbine can vary as the yaw angle of the fluid turbine changes due to the change in the angle of attack of the fluid on the shroud(s) or duct(s) of the fluid turbine. Torque, also referred to as a yaw moment, on the pivot structure can also vary considerably about the yaw axis during excessive fluid conditions.

Thus, it is known that excessive wind conditions and/or high speed gusts can cause fatigue loads and stress on the structural components of a fluid turbine, and can further cause twisting of power transfer cables within the fluid turbine. Means of preventing and/or reducing fatigue loads and stress on structural components of a fluid turbine, and twisting of power transfer cables, are therefore desired.

### SUMMARY

In accordance with embodiments of the present disclosure, example fluid turbines, e.g., ducted turbines or mixer-ejector augmented turbines, with a slip ring therein for transmission of electrical power or communication signals or both from a rotating component to a stationary component of the fluid turbine that reduces tangling or twisting of power cables within the fluid turbine are provided. In some embodiments, the fluid turbines include an encoder, e.g., an absolute encoder, an incremental encoder, a rotary encoder, and the like, for determining an angle of rotation of the rotating component relative to the stationary component.

In accordance with embodiments of the present disclosure, example fluid turbines are provided that include a turbine shroud and a rotor assembly disposed within the turbine shroud. The turbine shroud includes an inlet defining a leading edge. The turbine shroud includes an outlet defining a trailing edge. The rotor assembly includes a hub, at least one rotor blade engaged with the hub, and a nacelle. The nacelle can be pivotally engageable with a tower structure. The fluid turbines include a slip ring disposed within the nacelle. The slip ring can electrically connect one or more cables in the nacelle to one or more cables in the tower structure. The slip ring can be engaged with the nacelle by a mounting apparatus which allows movement of the slip ring along at least one of an x-axis, a y-axis and a z-axis.

In some embodiments, the slip ring can include at least one rotating component and at least one stationary component. The stationary component can be electrically connected to the one or more cables in the tower structure. In some embodiments, the rotating component includes at least one brush and the stationary component includes at least one contact ring. In some embodiments, the rotating component includes at least one contact ring and the stationary component includes at least one brush.

In some embodiments, a shaft of the slip ring can be engaged with the nacelle at a slip ring bracket. The slip ring bracket can allow automatic and/or manual movement or adjustment of the slip ring along at least one of the x-axis parallel to a central axis of the fluid turbine and the z-axis parallel to a yaw axis of the fluid turbine. In some embodiments, a slip ring housing can be engaged with a cable support structure. Engagement of the slip ring housing with the cable support structure can allow automatic and/or manual movement or adjustment of the slip ring along the y-axis perpendicular to a central axis and a yaw axis of the fluid turbine.

In some embodiments, the fluid turbines include an encoder, e.g., an absolute encoder, an incremental encoder, a rotary encoder, and the like, engaged with the slip ring and/or a shaft of the slip ring. The encoder can be configured to detect a rotation angle of the nacelle relative to the tower structure.

In some embodiments, the fluid turbines include an ejector shroud including an ejector shroud inlet defining an ejector shroud leading edge and an ejector shroud outlet defining an ejector shroud trailing edge. The outlet of the turbine shroud can extend downstream of the ejector shroud inlet. In some embodiments, at least one of the turbine shroud and the ejector shroud can include faceted sides. In some embodiments, the leading edge of the turbine shroud can define an annular edge and the trailing edge of the turbine shroud can define a rectilinear edge. In some embodiments, the fluid turbines include a passive yaw system for regulating yaw of the fluid turbine into a fluid flow direction.

In accordance with embodiments of the present disclosure, methods of maintaining untwisted electric cables in a fluid turbine are provided that include providing a fluid turbine as described above. The methods include rotating the nacelle relative to the tower structure. The methods include maintaining an electrical connection between electrical components disposed within the nacelle and electric cables in the tower structure with the slip ring during rotation of the nacelle relative to the tower structure. The methods further include maintaining the electric cables in the tower structure in an untwisted position with the slip ring during rotation of the nacelle relative to the tower structure.

In some embodiments, the methods include automatically and/or manually adjusting a position of the slip ring along at least one of an x-axis parallel to a central axis of the fluid turbine, a y-axis perpendicular to the central axis and a yaw axis of the fluid turbine, and a z-axis parallel to the yaw axis of the fluid turbine. In some embodiments, the methods include detecting a rotation angle of the nacelle relative to the tower structure with an encoder, e.g., an absolute encoder, an incremental encoder, a rotary encoder, and the like.

In accordance with embodiments of the present disclosure, example fluid turbines are provided that include a turbine shroud and a rotor assembly disposed within the turbine shroud. The turbine shroud includes an inlet defining a leading edge. The turbine shroud includes an outlet defining a trailing edge. The rotor assembly includes a hub, at least one rotor blade engaged with the hub, and a nacelle. The nacelle can be pivotally engageable with a tower structure. The fluid turbines include a slip ring disposed within the nacelle. The slip ring can electrically connect one or more cables in the nacelle to one or more cables in the tower structure. The slip ring can be engaged with the nacelle by a mounting apparatus which allows movement of the slip ring along at least one of an x-axis, a y-axis and a z-axis. In some embodiments, the fluid turbines include an encoder configured to detect a rotation angle of the nacelle relative to the tower structure.

In accordance with embodiments of the present disclosure, example fluid turbines are provided that provide power extraction improvements to an open rotor comprising multiple-element or a mixer-ejector airfoils. In some embodiments, the fluid turbines include at least one annular airfoil or shroud, e.g., a mixer shroud, a turbine shroud, a primary annular airfoil, and the like, in fluid communication with a circumference of a rotor plane. In some embodiments, the fluid turbines include at least one additional annular airfoil or shroud, e.g., an ejector shroud, a secondary annular airfoil, and the like, in fluid communication with an exit or trailing edge of the first annular airfoil.

The fluid stream passing over and through the annular airfoils can be divided into a low pressure-high velocity stream on the interior side of the airfoil and a high pressure-low velocity stream on the exterior of the airfoil. The high pressure-low velocity fluid stream can also be referred to as the bypass flow. In some embodiments, a mixer-ejector airfoil fluid turbine can assist in combining the bypass flow with fluid flow that has passed through the rotor plane. The combination of a primary annular airfoil and at least one secondary annular airfoil can result in a fluid turbine providing increased power extraction and efficiency over open rotor turbines.

In some embodiments, a means of stowing a fluid turbine during a loss of grid power in a manner that exhibits a reduction of or the lowest loads on the structural elements associated with the fluid turbine is provided. In some embodiments, a means of stowing a fluid turbine during a loss of grid power in a manner that exhibits a reduction of or the lowest possible yaw moment on the fluid turbine. The example means discussed herein further prevent excessive twisting of power and signal transmission cables located within the fluid turbine. The example means discussed herein further compensate for misalignment of the yaw axis of the nacelle of the fluid turbine with the vertical axis of the tower of the fluid turbine.

In some embodiments, in the event of a loss of connection to grid power and/or subsequent failure of mechanical braking systems, the fluid turbine can passively yaw to an orientation with the least yaw moment and/or the lowest loads on the structural components of the fluid turbine. In some embodiments, the fluid turbine exhibits the least yaw moment and the lowest loads on the structural components of the fluid turbine in an orientation in which the fluid turbine central axis is substantially perpendicular to the fluid flow direction.

As discussed above, changing fluid direction during a loss of connection to grid power may result in repeated rotation of the fluid turbine about the yaw axis as the fluid turbine continually and passively yaws perpendicular to the fluid flow direction. In order to prevent or reduce excessive twisting or over-twisting of power and/or communication transmission cables, in some embodiments, the fluid turbine includes a slip ring engaged between the nacelle and tower.

The slip-ring, also known as a rotary electrical interface, can be a rotary coupling used to transfer electric current from a stationary unit within the fluid turbine to a rotating unit within the fluid turbine. The slip ring can include one or more flexible contacts, e.g., brushes, that engage an electrically conductive race, e.g., one or more rings. In some embodiments, the brushes are configured as the stationary unit and the rings are configured as the mated rotating unit. In some embodiments, the rings are configured as the stationary unit and the brushes are configured as the mated rotating unit. The stationary unit and the rotating unit can be maintained in a mated configuration to maintain an electrical connection between the stationary unit and the rotating unit. Power can thereby be transferred between the stationary unit and the rotating unit.

In particular, power generated by the fluid turbine from the fluid stream can be transferred to the bottom of the tower and subsequently to a power grid through the slip ring. The slip ring can mitigate cable twisting and, in some embodiments, can eliminate the need for a bi-directional turbine yaw system to actively rotate the turbine in both directions to untwist the cables, while allowing the transfer of power or energy to the base of the fluid turbine tower. Rather, the slip ring can allow the fluid turbine to passively follow the fluid direction without twisting of the cables. In some embodiments, electronic communication to and from the power electronics in the fluid turbine can also be transferred through the slip ring.

In some embodiments, alignment of the yaw axis of the nacelle and the central axis of the tower can vary due to cumulative tolerances in the yaw drive and/or the bearing mechanisms. In some embodiments, the fluid turbine provides a means of allowing varying tolerances in the alignment of the nacelle yaw axis and the tower vertical axis, while maintaining an alignment of the slip ring with a mated shaft associated with the slip ring.

In some embodiments, the slip ring includes at least one stationary component, e.g., a stationary portion, and at least one rotating component, e.g., a rotating portion. In some embodiments, the rotating component is engaged with the nacelle and the stationary component is engaged with the tower. In some embodiments, a mounting apparatus, e.g., a housing, for containing at least one of the slip ring rotating portion and the slip ring stationary portion therein can be fixedly engaged with the nacelle of the fluid turbine. In some embodiments, the housing for the slip ring allows movement or adjustment of the stationary and/or rotating components of the slip ring relative to each other in at least one of the x-axis, the y-axis and the z-axis. In some embodiments, a housing for the rotating component can be laterally movably engaged with a horizontal member that provides lateral movement of the housing. In some embodiments, the horizontal member can be fixedly engaged with the nacelle. In some embodiments, the housing for the stationary component can be laterally movably engaged with a horizontal member that is, in turn, engaged with the tower structure, thereby providing lateral movement of the housing for the stationary component of the slip ring. In some embodiments, the two horizontal members can be substantially perpendicular to each other. In some embodiments, additional movement between the rotating component and the stationary component can be provided along the vertical axis.

In some embodiments, the fluid turbine includes an encoder, e.g., an absolute encoder, an incremental encoder, a rotary encoder, and the like, which provides a means of detecting and signaling the orientation of the nacelle about the yaw axis of the fluid turbine. In some embodiments, the encoder is engaged with the slip ring and transmits a signal referencing the rotation angle of the nacelle about the yaw axis. In some embodiments, a radial orientation of the nacelle about the yaw axis can be measured by an encoder engaged with the ring gear of a yaw mechanism.

In some embodiments, the fluid turbines include self-yaw or passive yaw characteristics providing a means of stowing the fluid turbine during a loss of grid power. The self-yaw or passive yaw can stow the fluid turbine at an angle to a fluid stream direction that exhibits the lowest loads on the structural components of the fluid turbine and/or the least possible yaw moment. In some embodiments, the fluid turbines include a means of passively maintaining the angle to the fluid stream direction during changing or varying fluid directions, e.g., during loss of grid power.

The fluid turbines include a mounting means for the rotating and stationary portions. In some embodiments, the mounting means for the rotating and stationary portions can be oriented along an opposing x-axis and y-axis. In some embodiments, the mounting means for the rotating and stationary portions can allow movement or adjustment of the rotating and stationary portions relative to each other along the x-axis, the y-axis and the z-axis. In some embodiments, the slip ring can be oriented along the z-axis.

Example fluid turbines in accordance with the present invention can be used to extract energy from a variety of suitable fluids, such as air, e.g., wind, and/or water. The aerodynamic principles of a wind turbine of the present invention also apply to hydrodynamic principles of a comparable water turbine and can be employed in conjunction with numerous fluid turbines. For the purpose of convenience, the present embodiment is described in relation to ducted wind turbine application. Such a description is solely for convenience and clarity and is not intended to be limiting in scope.

These and other non-limiting features or characteristics of the present disclosure are further described below. Any combination or permutation of embodiments is envisioned. Additional advantageous features, functions and applications of the disclosed assemblies, systems and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

The following is a brief description of the drawings, which are presented for the purposes of illustrating the disclosure set forth herein and not for the purposes of limiting the same. Example embodiments of the present disclosure are further described with reference to the appended figures. It is to be noted that the various features and combinations of features described below and illustrated in the figures can be arranged and organized differently to result in embodiments which are still within the spirit and scope of the present disclosure. To assist those of ordinary skill in the art in making and using the disclosed systems, assemblies and methods, reference is made to the appended figures, wherein:

FIG. 1 is a front perspective view of an example fluid turbine including a turbine shroud and an ejector shroud according to the present disclosure.

FIG. 2 is a side view of the example fluid turbine of FIG. 1.

FIG. 3 is a rear perspective, cross-sectional view of the example fluid turbine of FIG. 1 and a detailed view of a slip ring with the example fluid turbine of FIG. 1.

FIG. 4 is a front perspective view of an example fluid turbine including a turbine shroud according to the present disclosure.

### DETAILED DESCRIPTION

The example embodiments disclosed herein are illustrative of advantageous fluid turbine systems, and assemblies of the present disclosure and methods or techniques thereof. It should be understood, however, that the disclosed embodiments are merely examples of the present disclosure, which may be embodied in various forms. Therefore, details disclosed herein with reference to example fluid turbine systems or fabrication methods and associated processes or techniques of assembly and/or use are not to be interpreted as limiting, but merely as the basis for teaching one skilled in the art how to make and use the advantageous fluid turbine systems of the present disclosure.

A more complete understanding of the components, processes, and apparatuses disclosed herein can be obtained by reference to the accompanying figures. These figures are intended to demonstrate the present disclosure and are not intended to show relative sizes and dimensions or to limit the scope of the disclosed embodiment(s). In particular, the figures provided herein are not necessarily to scale and, in certain views, parts may be exaggerated for purposes of clarity.

Although specific terms are used in the following description, these terms are intended to refer only to particular structures in the drawings and are not intended to limit the scope of the present disclosure. It is to be understood that like numeric designations refer to components of like function.

The terms “about” or “approximately” when used with a quantity include the stated value and also have the meaning dictated by the context. For example, they include at least the degree of error associated with the measurement of the particular quantity. When used in the context of a range, the terms “about” or “approximately” should also be considered as disclosing the range defined by the absolute values of the two endpoints. For example, the range “from about 2 to about 4” or “from approximately 2 to approximately 4” also disclose the range “from 2 to 4”.

The term “rotor assembly” is used herein to refer to any assembly in which one or more blades or blade segments are attached to a shaft and are able to rotate, allowing for the generation or extraction of power or energy from fluid flow rotating the blade(s) or blade segments. Example rotors can include, e.g., a propeller-like rotor, a rotor/stator assembly, a multi-segment propeller-like rotor, or any type of rotor assembly understood by one skilled in the art that may be associated with the airfoil of the fluid turbines of the present disclosure.

Example annular shrouds (e.g., airfoils) discussed herein can include an inlet or a leading edge and an exit or a trailing edge with the lift or suction side of the shrouds on the side proximal to the rotor assembly. As discussed herein, the leading edge of a shroud can be considered the front of the fluid turbine system and the trailing edge of a shroud can be considered the rear of the fluid turbine system. A first component of the fluid turbine system located closer to the front of the fluid turbine system may be considered “upstream” of a second component located closer to the rear of the fluid turbine system. Put another way, the second component is considered to be “downstream” of the first component. The fluid stream passing over and through the annular shrouds can be divided into a low pressure-high velocity stream on the interior side of the shroud and a high pressure-low velocity stream on the exterior of the shroud. The high pressure-low velocity fluid stream can also be referred to as the bypass flow.

Example embodiments include, but are not limited to, a fluid turbine, e.g., a ducted turbine or a mixer-ejector fluid turbine, which provides an improved means of generating power from fluid currents. In some embodiments, the fluid turbine can include tandem cambered shrouds and a mixer-ejector pump. A turbine shroud assembly can be disposed about a rotor assembly, with the rotor assembly extracting power from a primary fluid stream. The tandem cambered shrouds and mixer-ejector pump can bring more flow through the rotor assembly than that of the flow through an open rotor assembly, thereby allowing greater energy extraction due to higher fluid flow rates. The mixer-ejector pump can transfer energy from the bypass flow to the rotor assembly wake flow by both axial and stream-wise vorticity, allowing higher energy extraction per unit mass flow rate through the rotor assembly. The increased flow through the rotor assembly combined with increased fluid flow mixing can result in an increase in the overall power production of the fluid turbine system.

In some embodiments, example fluid turbines can include a primary annular shroud, e.g., a mixer airfoil, a mixer shroud, a turbine shroud, and the like, defining a leading edge proximal to a rotor assembly which extracts power from a fluid stream. In some embodiments, the annular leading edge of the primary annular shroud can transition to a rectilinear shape at the trialing edge of the primary annular shroud. The configuration or orientation of the primary annular shroud can provide a means of introducing bypass flow into a region downstream of the rotor assembly. Introducing bypass flow into the region downstream of the rotor assembly can enhance the power generated by the fluid turbine system by increasing the amount of fluid flow through the fluid turbine system, increasing the fluid velocity at the rotor assembly for more power availability, and/or reducing back pressure on the fluid turbine blades in the rotor assembly.

Although discussed herein as annular shrouds, e.g., circular or ring shrouds, it should be understood that in some embodiments, other configurations, e.g., square, rectangular, oval, and the like, of the shrouds can be used. In some embodiments, the shrouds discussed herein can define an annular leading edge that transitions to a faceted trailing edge. In some embodiments, the faceted trailing edge can be in fluid communication with a trailing edge of a secondary annular airfoil, e.g., an ejector shroud. The ejector shroud can act as a mixer-ejector pump which provides increased fluid velocity near the inlet of the turbine shroud at the cross-sectional area of the rotor plane. The mixer-ejector pump further engages the wake behind the rotor plane.

In some embodiments, the shrouds discussed herein can be configured as planar or faceted annular airfoils. A faceted airfoil can include any number of facets or may be a ringed airfoil. Although the embodiments illustrates in the Figures are substantially symmetrical, it should be understood that asymmetrical configurations of example fluid turbines are also within the scope of the present invention.

In some embodiments, the fluid turbines provide a platform for an integrated passive yaw system. In some embodiments, passive yawing can be deployed by disengaging at least one clutch that is integrated into a gear mechanism(s) and used in fluid-flow velocities below a cut-in fluid-flow velocity, above a cut-out fluid-flow velocity and during grid loss or other protection system modes. The cut-in fluid velocity of a fluid turbine generally defines the fluid velocity at which the fluid turbine can begin generating electrical energy. A cut-out fluid velocity of a fluid turbine generally defines the point at which the fluid turbine is shut down to prevent damage to electrical generation and mechanical components due to excessive fluid velocity that would result in an excessive rotor speed. In some embodiments, the passive yaw damping system can be integrated into the yaw system of the fluid turbine to prevent over-torqueing caused by, e.g., excessive fluid speed, fluid gusts, and the like.

The example fluid turbines described herein include a turbine shroud that surrounds a rotor assembly. In some embodiments, the fluid turbines include an ejector shroud that surrounds the exit or trailing edge of the turbine shroud. The fluid turbines include a tower and a nacelle at positioned at the top of the tower. Electronics, e.g., power and/or communication electronics, electrical generation equipment, and the like, can be housed in the nacelle. Electrical power and/or communication signals can be transferred from the rotating nacelle to the stationary tower along electrical cables by a slip ring located within the fluid turbine. In some embodiments, both the stationary component and the rotating component of the slip ring can be movably engaged with support structures. The support structures can be configured to allow the stationary component and the rotating component to remain co-axial regardless of the axial alignment and/or vertical position of the nacelle relative to the tower.

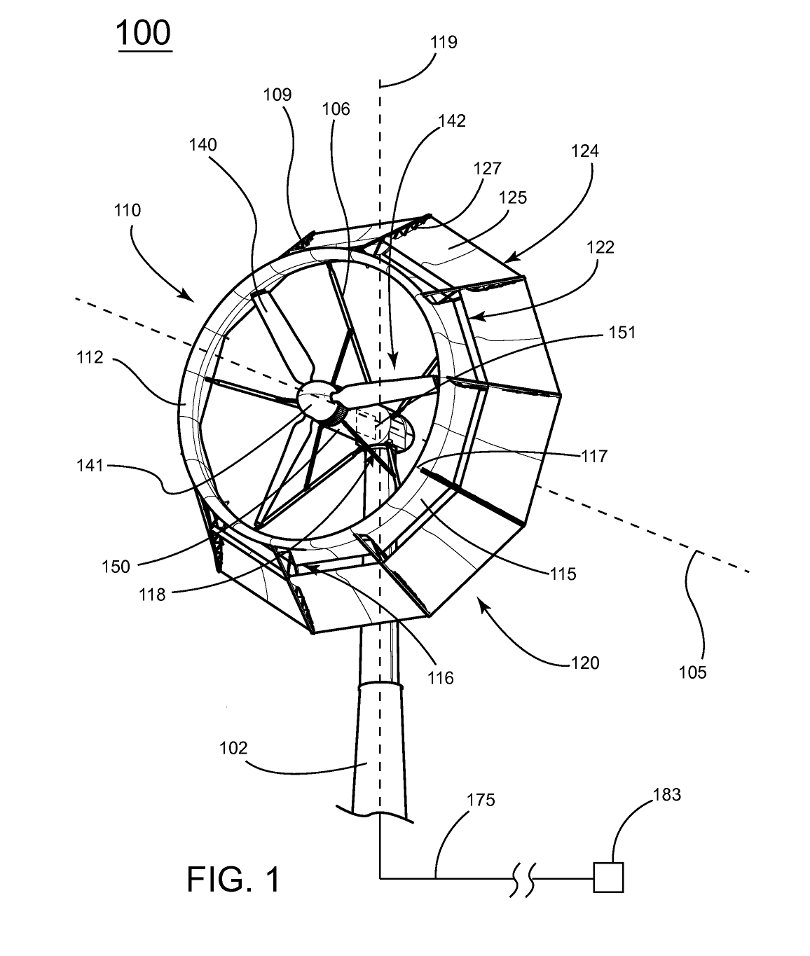

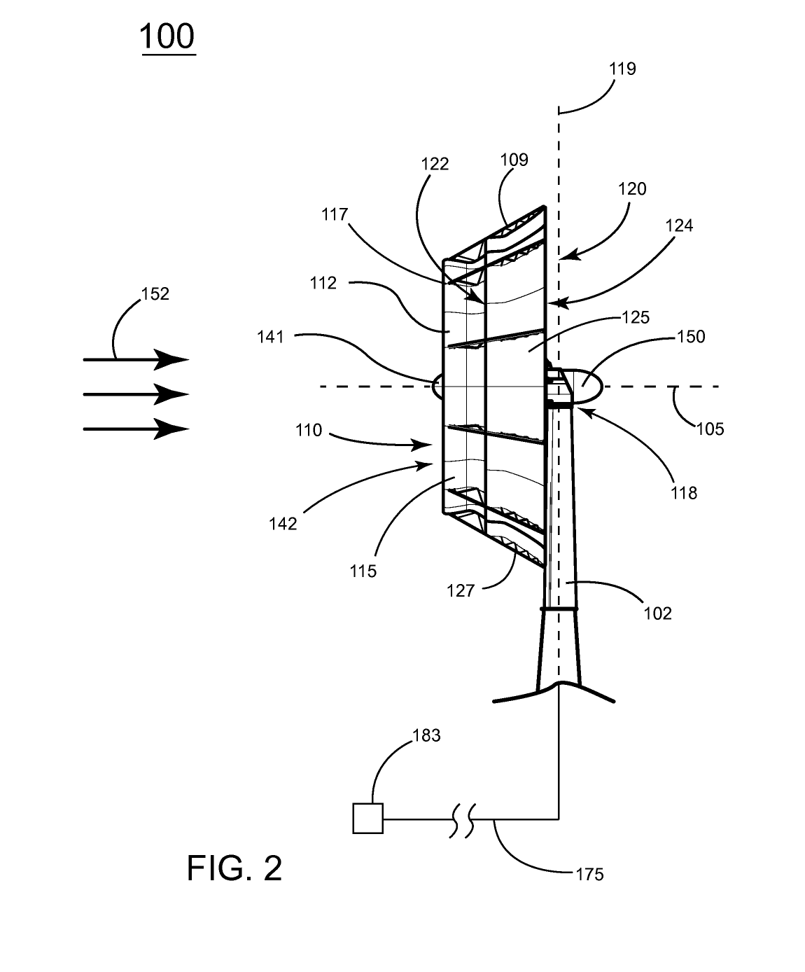

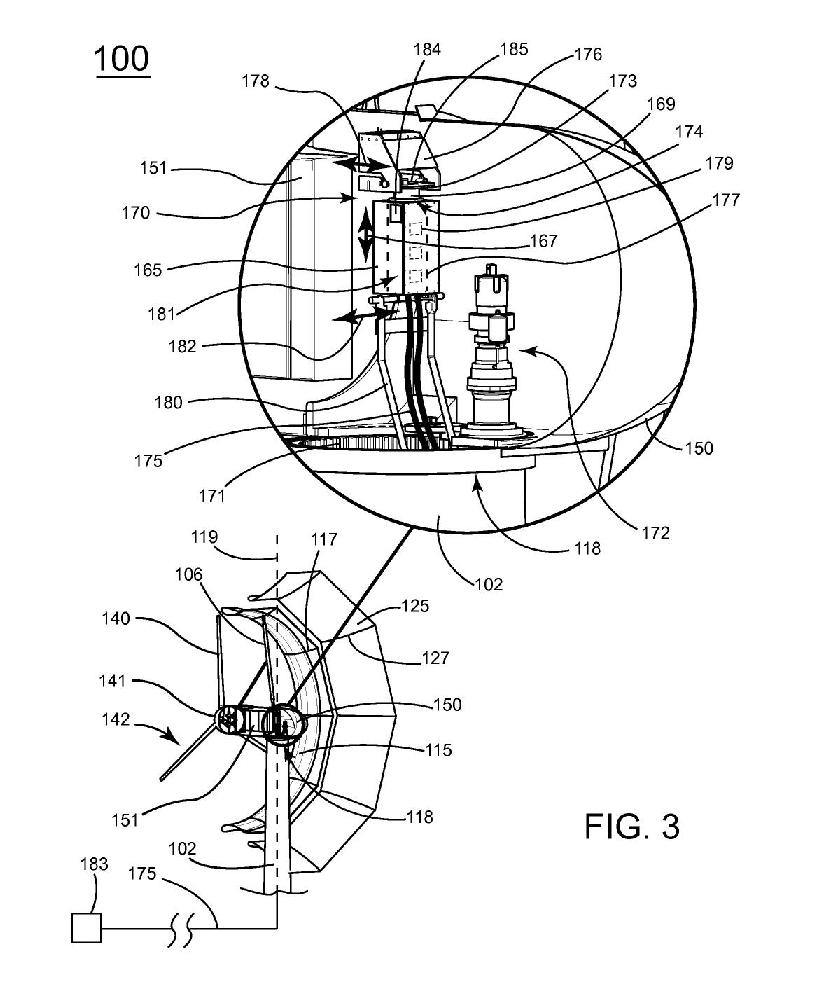

Turning now to FIG. 1, a front perspective view of an example embodiment of a fluid turbine 100 of the present disclosure including a turbine shroud 110, e.g., a primary annular airfoil, and an ejector shroud 120, e.g., a secondary annular airfoil, is provided. FIG. 2 is side view of the fluid turbine 100 of FIG. 1. FIG. 3 is a rear perspective, cross-sectional view and a detailed view of the fluid turbine 100 of FIG. 1. Numerous alternative shrouded or ducted fluid turbines may employ the features of the present invention. Thus, as would be understood by those of ordinary skill in the art, the example embodiment of shrouded turbine 100 illustrated in FIGS. 1-3 is not intended to be limiting in scope and is for illustrative purposes.

Although described herein as a faceted fluid turbine 100, those of ordinary skill in the art should understand that the example slip ring described herein can be utilized with non-faceted fluid turbines. In addition, although described herein as a fluid turbine 100 including a turbine shroud 110 and an ejector shroud 120, those of ordinary skill in the art should understand that the example slip ring described herein can be utilized with a fluid turbine including only a turbine shroud 110.

The fluid turbine 100 can include one or more rotor blades 140 that are joined at a central hub 141, e.g., a rotor hub, and rotate about a central axis 105. The hub 141 can be joined to a shaft that is co-axial with the hub 141 and with a nacelle 150. The nacelle 150 can house electrical equipment 151, e.g., power electronics, communication electronics, electrical generation equipment, and the like, therein. The hub 141 surrounds the body of the nacelle 150 at the proximal end of the rotor blades 140. The central hub 142 can be rotationally engaged with the nacelle 150 such that as the rotor blades 140 rotate, the central hub 142 simultaneously rotates relative to the nacelle 150.

The turbine shroud 110 can be in fluid communication with the rotor assembly 142 and can be co-axial with the central axis 105. For example, a fluid stream passing through the turbine shroud 110 can also pass through the rotor assembly 142. The turbine shroud 110 can further be co-axial with the rotor assembly 142, the hub 141 and the nacelle 150 about the central axis 105. The turbine shroud 110 includes a leading edge 112, also known as the inlet end or a front end, which can be substantially annular. The leading edge 112 can provide a relatively narrow gap between the rotor blade 140 tips and the interior surface of the leading edge 112.

In some embodiments, the leading edge 112 can be engaged with a series of substantially linear segments with substantially constant cross-sections, also known as turbine shroud facets 115, that each transition from the annular leading edge 112. Each of the turbine shroud facets 115 can enjoin adjacent turbine shroud facets 115 directly and/or at nodes 117, and can be supported by spars, support members or struts 106 connected to the nacelle 150. The turbine shroud 110 further includes a trailing edge 116, also known as the rear end, exhaust end or an exit of the turbine shroud 110. In some embodiments, the leading edge 112 can be annular or round and the trailing edge 116 can define linear faceted segments. The turbine shroud 110 can transition from the round leading edge 112 to the linear faceted segments of the trailing edge 116, while maintaining a curvature on the inner and outer surfaces of the turbine shroud 110. Thus, while the leading edge 112 defines a round structure, the trailing edge 116 of the turbine shroud 110 can define a polygonal structure defined by the interconnecting turbine shroud facets 115. In some embodiments, the leading edge 112 can transition into a substantially planar segment at a distance offset from the trailing edge 116, such that a portion of the cross-section of the turbine shroud 110 defines a linear faceted segment and/or a constant cross-sectional thickness. Although illustrated as a faceted trailing edge 116, in some embodiments, the turbine shroud 110 can include an annular trailing edge 116.

The ejector shroud 120 can be co-axial with the rotor assembly 142, the hub 140, the nacelle 150 and the turbine shroud 110. The ejector shroud 120 can include substantially linear faceted segments with substantially constant cross-sections, otherwise referred to as ejector shroud facets 125, each including trailing edges 124 and leading edges 122 that can be in fluid communication with the trailing edge 116 of the turbine shroud 110. Each of the ejector shroud facets 125 can enjoin adjacent ejector shroud facets 125 directly and/or at nodes 127. The leading edge 122 of the ejector shroud 120, e.g., an inlet end or a front end, can be positioned in-line with or partially upstream of the trailing edge 116 of the turbine shroud 110, e.g., an outlet or exit end. Thus, a fluid stream passing through the turbine shroud 110 can pass out of the trailing edge 116 and enter the ejector shroud 120 and/or mix with a fluid stream passing through the ejector shroud 120.

Facets 125 can enjoin at support members or struts 109 that support and connect the turbine shroud 110 and the ejector shroud 120 at the nodes 117, 127. In some embodiments, the leading edge 122 and the trailing edge 124 of the ejector shroud 120 can define linear faceted segments, e.g., a polygonal structure defined by the interconnecting ejector shroud facets 125. The linear faceted segment of the leading edge 122 can transition to the linear faceted segment of the trailing edge 124, while maintaining a curvature on the inner and outer surfaces of the ejector shroud 120. In some embodiments, the leading edge 122 can transition into a substantially planar segment at a distance offset from the trailing edge 124, such that a portion of the cross-section of the ejector shroud 120 defines a liner segment and/or a constant cross-sectional thickness. It should be understood that the number of facets 115, 125 shown in FIGS. 1 and 2 is illustrative and, in some embodiments, a greater or fewer number of similar facets 115, 125 can be utilized.

The turbine and ejector shrouds 110, 120 can be co-axial with the rotor blades 140, the central hub 141 and the nacelle 150 about the central axis 105. The turbine and ejector shrouds 110, 120 can be supported by a tower structure 102. The tower structure 102 can be pivotally or rotationally connected to the nacelle 150 at a pivot point 118 such that the fluid turbine 100 can yaw about the pivot point 118 along a yaw axis 119. In some embodiments, the yaw axis 119 can be substantially perpendicular to the central axis 150. Thus, the turbine shroud 110, the ejector shroud 120, the rotor blades 140, the hub 141 and the nacelle 150 can be pivotally or rotationally positioned relative to the tower structure 102 about the pivot point 118 to allow the fluid turbine 100 to passively yaw as the direction of the fluid stream changes.

As illustrated in FIG. 2, aerodynamic properties of the fluid turbine 100 can provide a means for the fluid turbine 100 to passively yaw or rotate about the pivot point 118 to substantially align the central axis 105 with the fluid stream 152 direction and position the front plane defined by the leading edge 112 of the turbine shroud 110 at approximately 90 degrees relative to the fluid stream 152 direction. Automatic alignment of the central axis 105 with the fluid stream 152 direction due to the aerodynamic properties of the fluid turbine 100 can reduce fatigue loads and/or a yaw moment of the structural components of the fluid turbine 100 during, e.g., excessive wind conditions and/or high speed gusts. For example, the loads on the fluid turbine 100 can be reduced when the fluid turbine 100 is in a shut-down mode, parked or otherwise not producing power, including instances when the fluid turbine 100 is disconnected from a power grid.

With reference to FIG. 3, a rear perspective, cross-sectional and detailed view of the fluid turbine 100 is provided. As illustrated in the detailed view of FIG. 3, a yaw mechanism 172 secured to the nacelle 150 can be mechanically engaged with tower structure 102 to allow rotation of the nacelle 150 relative to the tower structure 102. For example, a gear (not shown) of the yaw mechanism 172 extending into the tower structure 102 can mesh or engage the teeth of a gear ring 171 on an inner circumference of the tower structure 102 to permit controlled and rotatable engagement between the nacelle 150 and the tower structure 102.

The rotor assembly 142 and the hub 141 can be engaged with the electrical equipment 151, e.g., power electronics, communication electronics, and the like, housed within the nacelle 150. As the rotor blades 140 rotate, the electrical equipment 151 can convert the mechanical energy associated with rotation of the rotor assembly 142 into electrical energy. Electricity can be conducted from the electrical equipment 151 to a slip ring 170 located proximal to the yaw mechanism 172 and within the nacelle 150. The slip ring 170 can provide electrical connectivity between the electrical equipment 151, e.g., electrical generation equipment, power conditioning equipment, and the like, in the nacelle 150 and a base of the tower structure 102, while permitting continuous rotation of the nacelle 150 and the associated components of the fluid turbine 100 relative to the tower structure 102. For example, electrical connectivity can be provided between the electrical equipment 151 and one or more electric cables 175 extending through the tower structure 102 and to a power grid and/or storage 183.

In particular, the slip ring 170 includes an array of contact rings 169 engaged at the proximal end 173 with electrical equipment 151 in the nacelle 150. The contact rings 169 can be rotationally engaged at the distal end 174 with an array of rotating contacts 181 contained in a housing 165. In some embodiments, the rotating contacts 181 include a set of contacts that conduct three phase power and an additional set of rotating contacts that conduct information signals. In some embodiments, the rotating contacts 181 include at least one stationary contact ring 177, e.g., a stationary component or portion, engaged with at least one rotating brush 179, e.g., a rotating component or portion. In some embodiments, the contact ring 177 can be configured as the rotating component and the brush 179 can be configured as the stationary component.

The array of rotating contacts 181 can be engaged with electric cables 175. The electric cables 175 can extend from the housing 165 to the base of the tower structure 102 through the inner portion of the tower structure 102 where the captured electricity can be transferred to, for example, a power grid and/or storage 183. Thus, for example, as the nacelle 150 rotates about the pivot point 118, the rotating brush 179 simultaneously rotates while maintaining a continuous electrical connection relative to the stationary contact ring 177. The fluid turbine 100 can thereby passively yaw or pivot about the pivot point 118 relative to the fluid stream 152 direction while maintaining the electric cables 175 in a substantially untwisted position.

As discussed above, the housing 165 contains therein the rotating contacts 181, e.g., the stationary contact ring 177 and the rotating brush 179. In some embodiments, the housing 165 can be engaged with a shaft 185 of the slip ring 170 by means of one or more internal bearings. The shaft 185 of the slip ring 170 can be engaged with the nacelle 150 at a slip ring bracket 176, e.g., a mounting apparatus. In some embodiments, the slip ring bracket 176 can allow movement, translation or adjustment of the slip ring 170 and/or the housing 165 along an x-axis, e.g., parallel to the central axis 105 of the fluid turbine 100, as illustrated by the arrows 178. In some embodiments, the slip ring bracket 176 can be engaged with the shaft 185 of the slip ring 170 in such a manner as to allow movement, translation or adjustment of the slip ring 170 and/or the housing 165 along a z-axis, e.g., perpendicular to the central axis 105 of the fluid turbine 100, parallel to the yaw axis 119, and the like, as illustrated by the arrows 167.

In some embodiments, the housing 165 can be engaged with a cable support structure 180, e.g., a mounting apparatus. The cable support structure 180 can support the electric cables 175 and further maintains the electric cables 175 in an untwisted position. Engagement of the housing 165 with the cable support structure 180 can allow movement, translation or adjustment of the slip ring 170 and/or the housing 165 along a y-axis represented by the arrows 182, e.g., perpendicular to the movement along the x-axis as illustrated by arrows 178. In some embodiments, the automatic and/or manual adjustment or movement of the slip ring 170 can assist in compensating for misalignment of the yaw axis 119 of the nacelle 150 relative to a vertical axis defined by the tower structure 102 of the fluid turbine 100. In some embodiments, the housing 165, the slip ring bracket 176 and/or the cable support structure 180 can be configured to allow the stationary contact ring 177 and the rotating brush 179 to remain co-axial regardless of the axial alignment and/or vertical position of the nacelle 150 relative to the tower structure 102. In some embodiments, the housing 165, the slip ring bracket 176 and/or the cable support structure 180 can allow automatic and/or manual movement or adjustment of the nacelle 150 relative to the tower structure 102 while maintaining the contact ring 177 and the rotating brush 179 of the slip ring 170 co-axial relative to each other.

In some embodiments, an encoder 184, e.g., an absolute encoder, an incremental encoder, a rotary encoder, and the like, can be engaged with the slip ring 170, e.g., a shaft 185 of the slip ring 170, to detect the rotational orientation of the nacelle 150 about the yaw axis 119 as the nacelle 150 rotates relative to the tower structure 102. In some embodiments, the encoder 184 can transmit a signal notifying of a change in the rotation angle of the nacelle 150 and/or store the detected rotation angle of the nacelle 150 in a storage means.

The position of the slip ring 170 and/or the housing 165 can thereby be automatically adjusted, if necessary, to maintain the stationary contact ring 177 and the rotating brush 179 co-axial relative to each other as the nacelle 150 rotates or pivots along the pivot point 118 relative to the tower structure 102. In addition, during rotation of the nacelle 150 relative to the tower structure 102, the mated stationary contact ring 177 and the rotating brush 179 of the slip ring 170 can maintain a continuous electrical connection between the electrical equipment 151 and the grid and/or storage 183, while ensuring that the electric cables 175 are retained in an untwisted position.

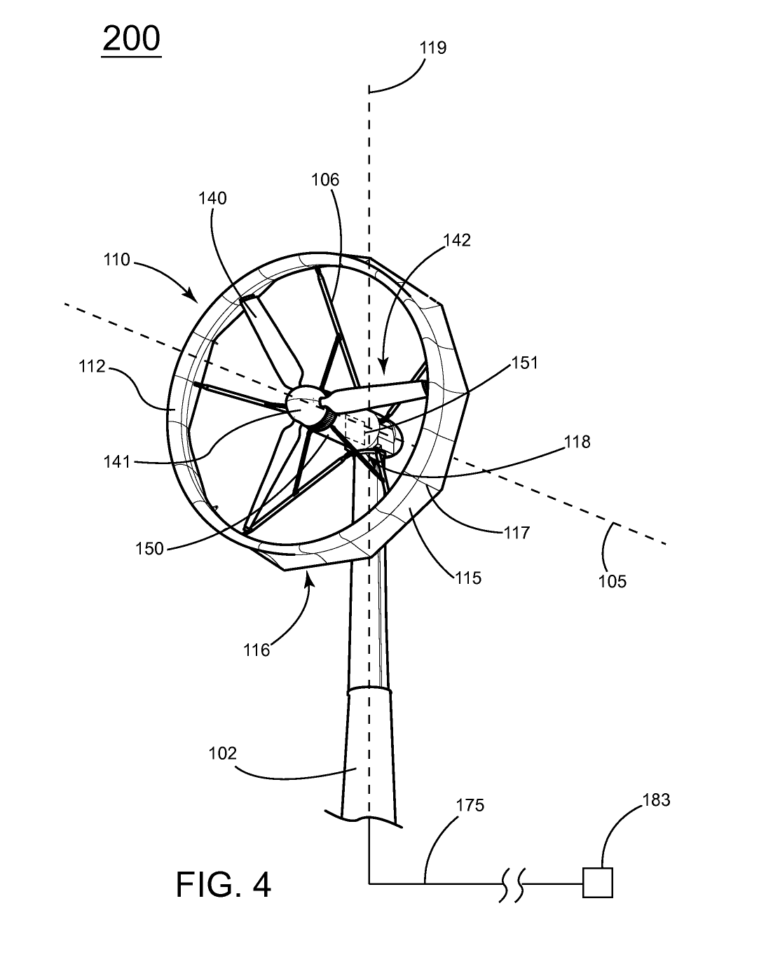

Turning now to FIG. 4, a front perspective view of an example embodiment of a fluid turbine 200 of the present disclosure including a turbine shroud 110, e.g., a primary annular airfoil, is provided. In particular, the fluid turbine 200 can be substantially similar in structure and function to the fluid turbine 100 of FIGS. 1-3, except that that fluid turbine 200 does not include the ejector shroud 120 and the components associated with the ejector shroud 120. Therefore, the fluid turbine 200 can be a single shrouded fluid turbine 200. Those of ordinary skill in the art should understand that the fluid turbine 200 can include the slip ring 170 and the components associated with the slip ring 170 described above to maintain an electrical connection between the nacelle 150 and the tower structure 102 during rotation of the nacelle 150 relative to the tower structure 102, while maintaining the electric cables 175 in a substantially untwisted position.

Although the systems and methods of the present disclosure have been described with reference to example embodiments thereof, the present disclosure is not limited to such example embodiments and or implementations. Rather, the systems and methods of the present disclosure are susceptible to many implementations and applications, as will be readily apparent to persons skilled in the art from the disclosure hereof. The present disclosure expressly encompasses such modifications, enhancements and or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

1. A fluid turbine, comprising:
a turbine shroud including an inlet defining a leading edge and an outlet defining a trailing edge,
a rotor assembly disposed within the turbine shroud, the rotor assembly including a hub, at least one rotor blade engaged with the hub, and a nacelle pivotally engageable with a tower structure, and
a slip ring disposed within the nacelle electrically connecting one or more cables in the nacelle to one or more cables in the tower structure, the slip ring being engaged with the nacelle by a mounting apparatus which allows movement of the slip ring along at least one of an x-axis, a y-axis and a z-axis.

2. The fluid turbine according to claim 1, wherein the slip ring includes a rotating component and a stationary component.

3. The fluid turbine according to claim 2, wherein the stationary component is electrically connected to the one or more cables in the tower structure.

4. The fluid turbine according to claim 1, wherein the slip ring maintains the electrical connection between the one or more cables in the nacelle and the one or more cables in the tower structure during rotation of the nacelle relative to the tower structure.

5. The fluid turbine according to claim 2, wherein the rotating component includes a brush and the stationary component includes a contact ring.

6. The fluid turbine according to claim 2, wherein the rotating component includes a contact ring and the stationary component includes a brush.

7. The fluid turbine according to claim 1, wherein a shaft of the slip ring is engaged with the nacelle at a slip ring bracket.

8. The fluid turbine according to claim 7, wherein the slip ring bracket allows movement of the slip ring along at least one of (i) the x-axis parallel to a central axis of the fluid turbine and (ii) the z-axis parallel to a yaw axis of the fluid turbine.

9. The fluid turbine according to claim 1, comprising a slip ring housing engaged with a cable support structure.

10. The fluid turbine according to claim 9, wherein engagement of the slip ring housing with the cable support structure allows movement of the slip ring along the y-axis perpendicular to a central axis and a yaw axis of the fluid turbine.

11. The fluid turbine according to claim 1, comprising an encoder engaged with the slip ring and configured to detect a rotation angle of the nacelle relative to the tower structure.

12. The fluid turbine according to claim 1, comprising an ejector shroud including an ejector shroud inlet defining an ejector shroud leading edge and an ejector shroud outlet defining an ejector shroud trailing edge.

13. The fluid turbine according to claim 12, wherein the outlet of the turbine shroud extends downstream of the ejector shroud inlet.

14. The fluid turbine according to claim 12, wherein at least one of the turbine shroud and the ejector shroud includes faceted sides.

15. The fluid turbine according to claim 1, wherein the leading edge of the turbine shroud defines an annular edge and the trailing edge of the turbine shroud defines a rectilinear edge.

16. The fluid turbine according to claim 1, comprising a passive yaw system for regulating yaw of the fluid turbine into a fluid flow direction.

17. A method of maintaining untwisted electric cables in a fluid turbine, comprising:
providing a fluid turbine, the fluid turbine including (i) a turbine shroud including an inlet defining a leading edge and an outlet defining a trailing edge, (ii) a rotor assembly disposed within the turbine shroud, the rotor assembly including a hub, at least one rotor blade engaged with the hub, and a nacelle pivotally engageable with a tower structure, and (iii) a slip ring disposed within the nacelle electrically connecting one or more cables in the nacelle to one or more cables in the tower structure, the slip ring being engaged with the nacelle by a mounting apparatus which allows movement of the slip ring along at least one of an x-axis, a y-axis and a z-axis, and rotating the nacelle relative to the tower structure.

18. The method according to claim 17, comprising adjusting a position of the slip ring along at least one of (i) the x-axis parallel to a central axis of the fluid turbine, (ii) the y-axis perpendicular to the central axis and a yaw axis of the fluid turbine, and (iii) the z-axis parallel to the yaw axis of the fluid turbine.

19. The method according to claim 17, comprising detecting a rotation angle of the nacelle relative to the tower structure with an encoder.

20. A fluid turbine, comprising:
a turbine shroud including an inlet defining a leading edge and an outlet defining a trailing edge,
a rotor assembly disposed within the turbine shroud, the rotor assembly including a hub, at least one rotor blade engaged with the hub, and a nacelle pivotally engageable with a tower structure, and
a slip ring disposed within the nacelle electrically connecting one or more cables in the nacelle to one or more cables in the tower structure, the slip ring being engaged with the nacelle by a mounting apparatus which allows movement of the slip ring along at least one of an x-axis, a y-axis and a z-axis, and
an encoder configured to detect a rotation angle of the nacelle relative to the tower structure.
